(19) United States
(12) Patent Application Publication
(10) Pub. No.: US 2014/0003090 A1
(43) Pub. Date: Jan. 2, 2014

(54) LIQUID CRYSTAL DISPLAY AND BACKLIGHT MODULE THEREOF

(71) Applicants: Kuang Yao Chang, Guangdong (CN); Lindong Fang, Guangdong (CN)

(72) Inventors: Kuang Yao Chang, Guangdong (CN); Lindong Fang, Guangdong (CN)

(73) Assignee: SHENZHEN CHINA STAR OPTOELECTRONICS TECHNOLOGY CO., LTD., Guangdong, P.R. (CN)

(21) Appl. No.: 13/142,567

(22) PCT Filed: May 31, 2011
(86) PCT No.: PCT/CN11/75038

§ 371 Date: Jun. 28, 2011

(30) Foreign Application Priority Data
May 16, 2011 (CN) 201120155801.7

(51) Int. Cl. F21V 8/00

(52) U.S. Cl. CPC G02B 6/0073
USPC 362/612

(57) ABSTRACT

Aspects relate to a liquid crystal display and a backlight module thereof, wherein said backlight module comprises an aluminum extrusion as well as an LED circuit board arranged on said aluminum extrusion and a light guide plate. The aluminum extrusion is provided with a locating part, which may lie between said LED and said light guide plate and be further butted with a light incidence plane of said light guide plate. By installing a locating part which lies between said LED and said light guide plate on the aluminum extrusion, the backlight module may enable the aluminum extrusion to be provided with the functions of locating the light guide plate and the LED. Certain aspects relate to reducing the locating factor for influencing the light-coupling distance between the LED and the light guide plate so that it guarantees the light coupling efficiency.

### CROSS REFERENCE TO RELATED APPLICATIONS

This is a U.S. National Phase Application under 35 U.S.C. §371 of International Application No. PCT/CN2011/075038, filed May 31, 2011, which claims priority to CN 201120155801.7 filed on May 16, 2011, the entire contents of which are incorporated herein by reference in their entirety.

### FIELD OF THE INVENTION

The invention relates to the technical field of backlight module, and in particular to a backlight module and liquid crystal display thereof capable of improving the light coupling efficiency.

### BACKGROUND OF THE INVENTION

In present technology, the light coupling distance between the LED and the LGP (Light Guide Plate) is an important factor to influence the light utilization ratio of the backlight module. It will be known according to the simulated result that the light coupling efficiency is 100% when the light coupling distance is zero; the light coupling efficiency is 87.2% when the light coupling distance is 0.3 mm; the light coupling efficiency is 82% when the light coupling distance is 0.5 mm; and the light coupling efficiency is 70% when the light coupling distance is 1 mm. In the backlight module with an aluminum extrusion of present technology, shearing two notches on the light guide plate and then installing a locating column on the notch edge in order to install the light guide plate on said aluminum extrusion; the LED lies on one side of said light guide plate and is fixed on the aluminum extrusion. In the backlight module provided by the present technology, the light coupling distance between the LED (Light Emitting Diode) and the light guide plate is hard to be guaranteed. And there are many factors which may influence the light coupling distance such as the diameter accuracy of the locating column for mounting the light guide plate, the cutting tolerance of the light guide plate, the manufacturing tolerance between the LED SMT (LED Surface Mounted Technology) and the PCB (Printed Circuit Board) as well as the thickness of the heat dissipation pad and other factors. In present technology, the general light coupling distance for the LED is about 1 mm since there are too many locating factors for said light guide plate so that cause a larger combination tolerance; and as a result, the light coupling distance is difficult to be guaranteed.

In addition, according to the design of the location dimension of the light guide plate in present technology, the tolerance (0.515 mm) of the light coupling distance in the present technology is larger than the light coupling distance (0.5 mm) while calculating with the deviation tolerances; therefore, the light guide plate may touch the LED, and this is why the limit value of the light coupling distance in the present technology is 0.5 mm.

### SUMMARY OF THE INVENTION

Aspects of this disclosure provide a liquid crystal display and a backlight module thereof. Further aspects aim to fix and locate the LED and/or the light guide plate so as to reduce the influence towards the location dimension of the light coupling distance between the LED and the light guide plate.

In accordance with one embodiment, a backlight module, comprising an aluminum extrusion and an LED (Light Emitting Diode) circuit board as well as a light guide plate arranged on said aluminum extrusion, wherein said LED circuit board is provided with an LED. In one embodiment, said aluminum extrusion is provided with a locating part, which may lie between said LED and said light guide plate and is further butted with a light incidence plane of said light guide plate.

In on embodiment, the light coupling distance between said LED and said light guide plate may be less than or equal to 0.5 mm.

In another embodiment, said locating part is a strip-shaped baffle wall arranged on the bottom of said aluminum extrusion; said strip-shaped baffle wall lies between said LED and said light guide plate.

In yet another embodiment, said locating part is a hook-like part arranged on the top of said aluminum extrusion.

In still yet another embodiment, said LED is arranged into a groove of said hook-like part by the method of fixed-axis rotation or said LED is arranged into a groove of said hook-like part by the method of drawer.

In still yet another embodiment, said light guide plate is provided with a back panel and said back panel is fixedly arranged at the bottom of said aluminum extrusion.

In still yet another embodiment, said back panel is fixedly arranged on the bottom of said aluminum extrusion by fixing screws.

In still yet another embodiment, a heat-conducting cream or a heat-conducting adhesive is arranged between said LED circuit board and said aluminum extrusion.

In still yet another embodiment, said LED circuit board is fixedly arranged on said aluminum extrusion by fixing screws.

Another aspect of the invention further provide another backlight module, comprising an aluminum extrusion, a light guide plate as well as an LED (Light Emitting Diode) circuit board arranged on said aluminum extrusion, wherein said LED circuit board is provided with an LED and said aluminum extrusion is provided with a locating part; said locating part lies between said LED and said light guide plate and is further butted with a light incidence plane of said light guide plate; said locating part is a hook-like part arranged on the top of said aluminum extrusion; and the external end of said hook-like part lies between said LED and said light guide plate.

In one embodiment, said LED is arranged into a groove of said hook-like part by the method of fixed-axis rotation or by the method of drawer.

In another embodiment, said light guide plate is provided with a back panel and said back panel is fixedly arranged at the bottom of said aluminum extrusion.

In yet another embodiment, said back panel is fixedly arranged on the bottom of said aluminum extrusion by fixing screws.

In still yet another embodiment, a heat-conducting cream or a heat-conducting adhesive is arranged between said LED circuit board and said aluminum extrusion.

In still yet another embodiment, said LED circuit board is fixedly arranged on said aluminum extrusion by fixing screws.

According to another aspect of this disclosure, a liquid crystal display comprising a backlight module may include an aluminum extrusion, a light guide plate as well as an LED (Light Emitting Diode) circuit board arranged on said aluminum extrusion. In one embodiment, said LED circuit board is provided with an LED and said aluminum extrusion is provided with a locating part and said locating part lies between said LED and said light guide plate and is further butted with a light incidence plane of said light guide plate. In one embodiment, said locating part may comprise either: (1) a hook-like part arranged on the top of said aluminum extrusion in which the external end of said hook-like part lies between said LED and said light guide plate; (2) said locating part may comprise a strip-shaped baffle wall arranged on the bottom of said aluminum extrusion, in which said strip-shaped baffle wall lies between said LED and said light guide plate; or (3) combinations thereof.

In one embodiment, the light coupling distance between said LED and said light guide plate is less than or equal to 0.5 mm.

In one embodiment, said LED is arranged into a groove of said hook-like part by the method of fixed-axis rotation or by the method of drawer.

In one embodiment, a heat-conducting cream or a heat-conducting adhesive is arranged between said LED circuit board and said aluminum extrusion.

Various aspects of the invention implement one or more technical solutions having one or more of the following beneficial effects: the liquid crystal display and the backlight module thereof provided by one or more embodiments enables the aluminum extrusion to have the function of locating the light guide plate and the LED through installing a locating part on the aluminum extrusion that lies between said LED and said light guide plate. In certain embodiments, this arrangement avoids the influence towards the location accuracy for locating the LED and/or the light guide plate due to the diameter accuracy of the location column of the light guide plate and also avoids the influence towards the location dimension of the light coupling distance for the LED and the light guide plate due to the insufficient shearing accuracy of the light guide plate; since there are fewer location factors that may influence the light coupling distance for the LED and the light guide plate. Thus, in certain embodiments, the location dimension for the light coupling distance is guaranteed to correspond with the designed value to the largest extent; meanwhile, the location effect will not be influenced by the planeness of the light incidence plane of the light guide plate through the butt jointing the locating part with the light incidence plane of said light guide plate; thereby, the light coupling efficiency can be guaranteed. Moreover, the backlight modules described herein may be suitable for the side-accessing LED backlight or module or other application fields with the light coupling distance less than 0.5 mm (or equal to 0.5 mm).

### DESCRIPTION OF ATTACHED DRAWINGS

FIG. 1 is the schematic diagram showing the backlight module structure for the first exemplary embodiment of the invention;

FIG. 2 is the schematic diagram showing the backlight module structure for the second exemplary embodiment of the invention;

FIG. 3 is the schematic diagram showing an assembly of the backlight module illustrated in FIG. 2;

FIG. 4 is the schematic diagram showing another assembly of the backlight module illustrated in FIG. 2;

FIG. 5 is the schematic diagram showing the backlight module structure for the third exemplary embodiment of the invention.

The purpose implementation, the function features and advantages of the illustrated embodiments of the invention will be further illustrated by integrating the exemplary embodiments and taking the attached drawings as references.

### DETAILED DESCRIPTION OF THE EMBODIMENTS

In order to make the purpose, the technical solution and the advantage of the invention to be understood clearer, aspects of the invention will be further illustrated according to the attached drawings and the exemplary embodiment. It will be understood that the described exemplary embodiment is only use for illustrating this invention rather than limiting.

The backlight module provided by an embodiment of the invention comprises an aluminum extrusion as well as an LED (Light Emitting Diode) circuit board arranged on said aluminum extrusion and a light guide plate; said LED circuit board is provided with an LED; said aluminum extrusion is provided with a locating part; said locating part lies between said LED and said light guide plate and is further butted with a light incidence plane of said light guide plate. The area of the locating part on the aluminum extrusion for locating and contacting with the light guide plate is not the effectively used light incidence area of the light guide plate (such light incidence area is the one which is against towards the LED light emission plane and lies within the light emission angle of the LED); so although the light guide plate is abraded due to the direct contact between the aluminum extrusion and the light guide plate, the image quality of the module or the backlight will not be influenced; and since the whole strip of aluminum extrusion is contacted with the light guide plate with a larger stressed area, the cracking for the light guide plate will not occur. The light guide plate and/or the LED is fixed or located by the locating part of the aluminum extrusion, as a result, the location dimension of the light coupling distance for the LED and the light guide plate would not be influenced by the insufficient shearing accuracy of the light guide plate in present technology; moreover, the location factor for influencing the light coupling distance for the LED and the light guide plate is reduced; thus the location dimension for the light coupling distance is guaranteed to correspond with the designed value to the largest extent so as to guarantee the light coupling efficiency.

FIG. 1 shows the schematic diagram of the backlight module structure for the first exemplary embodiment of the invention. Such backlight module comprises an aluminum extrusion 102 as well as an LED circuit board 103 arranged on said aluminum extrusion 102 and a light guide plate 101; said LED circuit board 103 is provided with an LED 104; the bottom part of the aluminum extrusion 102 is provided with a strip-shaped baffle wall 105, and such strip-shaped baffle wall 105 lies between the LED 104 and the light guide plate 101 and is further butted with the light incidence plane of said light guide plate 101. In such backlight module, the strip-shaped baffle wall 105 on the aluminum extrusion 102 for the purpose of locating is contacted with the non light incidence area of the light guide plate 101 rather than contacted with the effectively used light incidence area of the light guide plate 101 (such area is against towards the LED light emission plane and lies within the light emission angle of the LED); so although the light guide plate is abraded due to the direct contact between the aluminum extrusion 102 and the light guide plate 101, the image quality of the module or the backlight will not be influenced; and since the whole strip of aluminum extrusion 102 is contacted with the light guide plate 101 with a larger stressed area, the cracking for the light guide plate 101 will not occur. Since the strip-shaped baffle wall 105 is used for fixing the position of the light guide plate 101 and locating the light guide plate 101 as well as the LED 104, there is no need to use a locating column and to incise the light guide plate; as a result, the influence towards the light coupling distance due to the diameter accuracy of the locating column and the shearing accuracy of the light guide plate can be reduced so that the light coupling efficiency is guaranteed.

Wherein further, a heat-conducting cream or a heat-conducting adhesive 106 can be arranged on the side wall between said LED circuit board 103 and said aluminum extrusion 102, which can either fix the LED circuit board 103 or more excellently radiate the heat of the LED circuit board 103. Wherein, said aluminum extrusion 102 comprises a strip-shaped bottom part 123, and the upper side of said bottom part 123 is provided with a protruded strip part 121 for mounting such light guide plate 101; one side of said bottom part is provided with a lateral part 122 which is vertical to such bottom part; a heat-conducting adhesive or heat-conducting cream 106 is arranged between the lateral side of said lateral part 122 and the LED circuit board 103.

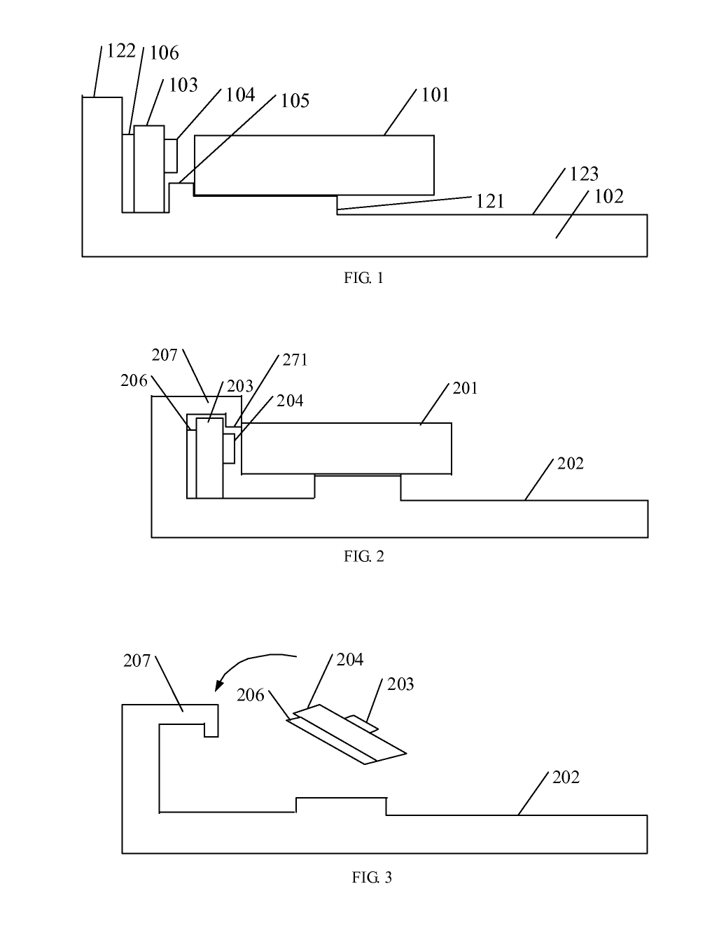

FIG. 2 shows the schematic diagram of the backlight module structure for the second exemplary embodiment of the invention. The main difference between the backlight module and the backlight module in the first exemplary embodiment lies as follows: one end of the aluminum extrusion 202 of the backlight module is provided with a hook-like part 207; the front end 271 of such hook-like part 207 lies between said light guide plate 201 and the LED 204 and is also butted with the light incidence plane of the light guide plate 201; one side of the LED circuit board 203 is arranged on the inner side wall of the hook-like part 207 for the aluminum extrusion; and the LED 204 is arranged on the other side of the LED circuit board 203; a heat-conducting adhesive or heat-conducting cream 206 is arranged between one side of such LED circuit board 203 and the inner side wall of the aluminum extrusion 202.

Since the front end 271 of the hook-like part 207 lies between said light guide plate 201 and said LED 204 and is butted with the light incidence plane of the light guide plate 201, so that the location for the LED 204 and the light guide plate 201 can be implemented; moreover, it avoids the influence towards the location dimension of the light coupling distance for the LED and the light guide plate due to the insufficient diameter accuracy of the locating column of the light guide plate and the shearing accuracy of the light guide plate; and it reduces the location factors that may influence the light coupling distance for the LED and the light guide plate, so that guarantees the locating dimension of the light coupling distance to correspond with the designed value to the largest extent.

In the exemplary embodiment of shown by FIG. 2, it is supposed that the target light coupling distance is 0.5 mm and then the practical light coupling distance d=0.5±0.4 mm is obtained according to the computing method of the tolerance and cooperation in the mechanical field; such tolerance of the light coupling distance (0.4 mm) is smaller than the light coupling distance (0.5 mm), thus the light guide plate will not be contacted with the LED. Therefore, the above mentioned exemplary embodiment is suitable for the side-accessing LED backlight or module or other application fields with the light coupling distance less than 0.5 mm (or equal to 0.5 mm).

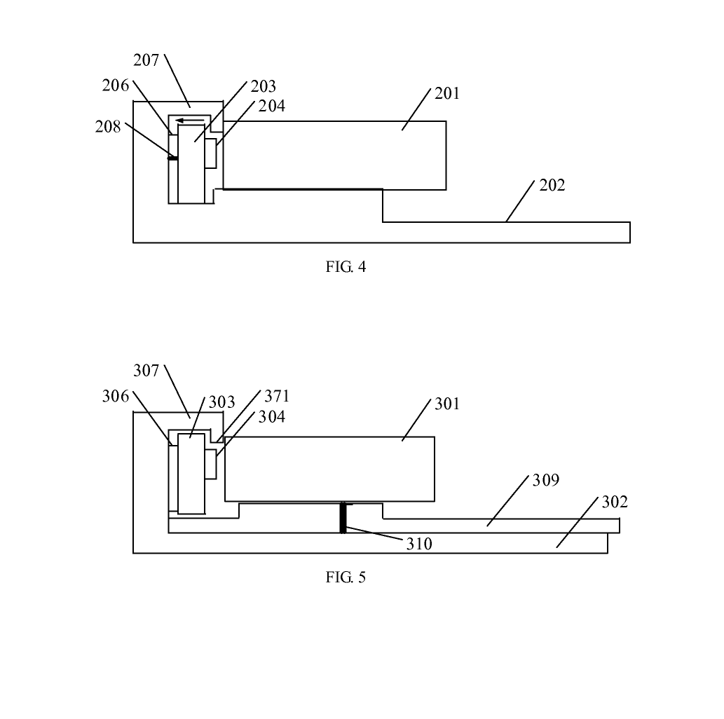

FIG. 3 shows the schematic diagram for assembling the LED circuit board of the backlight module of FIG. 2. The LED circuit board 203 and the LED 203 arranged thereon are installed into the groove of the hook-like part 207 for the aluminum extrusion 202 by the method of rotating. Moreover, a heat-conducting adhesive or heat-conducting cream 206 is arranged between such LED circuit board 203 and the aluminum extrusion 202.

FIG. 4 shows the schematic diagram for assembling the light guide plate of the backlight module of FIG. 2. Based on the backlight module which is provided by the second exemplary embodiment, the LED circuit board 203 is arranged into the groove of the hook-like part 207 by the method of drawer. Moreover, the LED circuit board 203 can be further fixed on the lateral end of the aluminum extrusion 202 by the screws 208 in order to strengthen its fixing more.

FIG. 5 is the schematic diagram showing the backlight module structure for the third exemplary embodiment of the invention. The main difference between the backlight module provided by this exemplary embodiment and the backlight module provided by the second exemplary embodiment lies as follows. The backlight module is further provided with a back panel 309 and such back panel 309 is fixedly arranged on the bottom part of the aluminum extrusion 302; specifically, as is shown by FIG. 5 that the backlight module comprises the aluminum extrusion 302, a light guide plate 301 as well as a LED circuit board 303 arranged on the aluminum extrusion 302; the LED circuit board 303 is provided with an LED 304; one end of the aluminum extrusion 302 is provided with a hook-like part 307. The back panel 309 is fixedly arranged on the bottom part of the aluminum extrusion 302, and such back panel 309 is fixedly arranged on the bottom part of the aluminum extrusion 302 by screws. Wherein, further speaking, a heat-conducting adhesive or heat-conducting cream 306 is arranged on the lateral end between the LED circuit board 303 and the aluminum extrusion 302; as a result, it can either fix the PCB (Printed Circuit Board) 303 or radiate the heat of the LED circuit board 303. The front end 271 of the hook-like part 307 lies between said light guide plate 301 and said LED 304 and is further butted with the light incidence plane of said light guide plate 301 in order to locate the LED 304 and the light guide plate 301 and limit the light guide plate 301 and the LED 304 to move in the direction of the light coupling distance. The backlight module neither needs the locating column nor the shearing light guide plate, it only needs to use the hook-like part 307 to locate the light guide plate 301 and the LED 304; as a result, the factors for influencing the light coupling distance is reduced so as to guarantee the locating dimension of the light coupling distance to correspond with the designed value to the largest extent. Additionally, in such backlight module, the hook-like part 307 on the aluminum extrusion 302 for the purpose of locating is contacted with the non light incidence area of the light guide plate 301 rather than contacted with the effectively used area of the light incidence plane for the light guide plate 301; therefore, the abrasion for the light guide plate 301 caused by the directly contact between the aluminum extrusion 302 and the light guide plate 301 will still not affect the image quality of the backlight module; and since the whole strip of aluminum extrusion 302 is contacted with the light guide plate 301 and the light guide plate 301 is provided with a larger stressed area, the cracking for the light guide plate 301 will still not occur. Besides, the backlight module enables the aluminum extrusion 302 to be exposed so that it is beneficial to the convection radiation.

In the preferably-selected exemplary embodiment, the back panel 309 is fixedly arranged on the bottom part of the aluminum extrusion by fixing screws 310. It is beneficial for the convection radiation by fixing the back panel 309 with screws 310 on the aluminum extrusion to expose the aluminum extrusion 302. In other exemplary embodiments, the back panel 309 can be fixed on the bottom part of the aluminum extrusion 302 by the method of gluing.

The exemplary embodiment of the invention further provides a liquid crystal display, comprising any backlight module in the above mentioned exemplary embodiments. Such backlight module of the liquid crystal display limits the movement for the light guide plate and the LED in the direction of the light coupling distance by locating the light guide plate and the LED; it also avoids the influence towards the location dimension of the light coupling distance for the LED and the light guide plate due to the insufficient diameter accuracy of the locating column of the light guide plate and the shearing accuracy of the light guide plate; besides, it reduces the locating factor for influencing the light-coupling distance between the LED and the light guide plate so that it guarantees the locating dimension of the light coupling distance to correspond with the designed value to the largest extent.

What is illustrated above is just a better exemplary embodiment, which is not used for limiting this invention. Any modifications, equivalent replacements and improvements within the spirit and principle of the invention should be included into the protection scope of the invention.

What is claimed is:

1. A backlight module, comprising:
an aluminum extrusion comprising:
a bottom portion extending a first horizontal distance along a horizontal axis;
a locating part for a light guide plate having a first surface that is perpendicular to the horizontal axis; and
a lateral wall perpendicularly extending from the bottom portion;
an LED circuit board located between the lateral wall and the locating part, said LED circuit board having a back surface configured to be mountable to the lateral wall, and a front surface that comprises an LED; and
a light guide plate mounted in a parallel arrangement with respect to the bottom portion of the aluminum extrusion such that a non-light incidence area along a light incidence plane of the plate is butted with the first surface of the locating part.

2. The backlight module according to claim 1, wherein a light coupling distance between said LED and said light guide plate is less than or equal to 0.5 mm.

3. The backlight module according to claim 1, wherein said locating part comprises a strip-shaped baffle wall arranged on and perpendicularly extending from the bottom of said aluminum extrusion; said strip-shaped baffle wall lies between said LED and said light guide plate.

4. The backlight module according to claim 1, wherein said locating part comprises a hook-like part extending along a parallel direction with respect to the bottom of the extrusion and forming a top of said aluminum extrusion;
wherein the hook-like part forms an external end configured to lie between said LED and said light guide plate.

5. The backlight module according to claim 4, wherein said LED is arranged into a groove of said hook-like part by the method of fixed-axis rotation or by the method of drawer.

6. The backlight module according to claim 4, wherein said light guide plate further comprises a back panel and said back panel is fixedly arranged at the bottom of said aluminum extrusion.

7. The backlight module according to claim 6, wherein said back panel is fixedly arranged on the bottom of said aluminum extrusion by screws.

8. The backlight module according to claim 6, further comprising a heat-conducting cream or a heat-conducting adhesive arranged between said LED circuit board and said aluminum extrusion.

9. The backlight module according to claim 8, wherein said LED circuit board is fixedly arranged on said aluminum extrusion by fixing screws

10. A backlight module, comprising:
an aluminum extrusion comprising:
a bottom portion extending a first horizontal distance along a horizontal axis;
a lateral wall perpendicularly extending from the bottom portion; and
a hook-like part extending from the lateral wall comprising:
a first member that forms a top portion of said aluminum extrusion; and
an external end that extends downward from the first member to create a locating portion that lies between an LED circuit board and a Light guide plate;
wherein the LED circuit board comprises a back surface configured to be mountable to the lateral wall, and a front surface that comprises an LED; and
a light guide plate mounted in a parallel arrangement with respect to the horizontal axis such that a non-light incidence area along a light incidence plane of the plate is butted with the external end of the locating part.

11. The backlight module according to claim 10, wherein said LED is arranged into a groove of said hook-like part by the method of fixed-axis rotation or by the method of drawer.

12. The backlight module according to claim 10, wherein said light guide plate further comprises with a back panel and said back panel is fixedly arranged at the bottom of said aluminum extrusion.

13. The backlight module according to claim 12, wherein said back panel is fixedly arranged on the bottom of said aluminum extrusion by fixing screws.

14. The backlight module according to claim 12, further comprising a heat-conducting cream or a heat-conducting adhesive arranged between said LED circuit board and said aluminum extrusion.

15. The backlight module according to claim 14, wherein said LED circuit board is fixedly arranged on said aluminum extrusion by fixing screws.

16. A liquid crystal display, comprising:
a backlight module, wherein said backlight module comprises an aluminum extrusion comprising:
a bottom portion extending a first horizontal distance along a horizontal axis;
a lateral wall perpendicularly extending from the bottom portion; and
a locating part for a light guide plate having a first surface that is perpendicular to the horizontal axis;
an LED circuit board comprising a back surface configured to be mountable to the lateral wall, and a front surface that comprises and LED;
a light guide plate mounted in a parallel arrangement with respect to the horizontal axis such that a non-light incidence area along a light incidence plane of the plate is butted with the locating part, wherein
a hook-like part extending from the lateral wall that includes a first member that forms a top portion of said aluminum extrusion and an external end that extends downward from the first member to create a locating portion that lies between an LED circuit board and a light guide plate;
a baffle wall that perpendicularly extends from the bottom portion between said LED and said light guide plate; and
combinations thereof.

17. The liquid crystal display according to claim 16, wherein a light coupling distance between said LED and said light guide plate is less than or equal to 0.5 mm.

18. The liquid crystal display according to claim 17, wherein said LED is arranged into a groove of said hook-like part by the method of fixed-axis rotation or by the method of drawer.

19. The liquid crystal display according to claim 18, wherein a heat-conducting cream or a heat-conducting adhesive is arranged between said LED circuit board and said aluminum extrusion.

20. The liquid crystal display according to claim 16, wherein the light guide plate extends a second horizontal distance along the horizontal axis that is less than the first horizontal distance.
